(19) United States
(12) Patent Application Publication
(10) Pub. No.: US 2026/0291120 A1
(43) Pub. Date: Sep. 24, 2026

(54) TERMINAL BLOCK

(71) Applicant: Yazaki Corporation, Tokyo (JP)

(72) Inventors: Yusuke TSUTAGAWA, Shizuoka (JP); Masato Akino, Shizuoka (JP); Masatoshi Yamada, Shizuoka (JP); Yasuhiro Tanaka, Shizuoka (JP); Sota Arai, Shizuoka (JP)

(73) Assignee: Yazaki Corporation, Tokyo (JP)

(21) Appl. No.: 19/536,921

(22) Filed: Feb. 11, 2026

(30) Foreign Application Priority Data
Mar. 18, 2025 (JP) 2025-043716

(51) Int. Cl. H01R 13/52; H01R 13/422; H01R 13/436; H01R 13/447

(52) U.S. Cl. CPC H01R 13/5213; H01R 13/4223; H01R 13/4362; H01R 13/447; H01R 13/5202

(57) ABSTRACT

A terminal block includes a housing and a seal member. The housing includes: an attachment surface that abuts on an attachment target; a busbar holding portion that holds a busbar extending in an axial direction; and an annular recessed groove provided, in an annular shape, on the attachment surface outside the busbar holding portion around the axial direction and having a bottom surface and a side wall rising from the bottom surface. The seal member has an annular shape and is provided in the annular recessed groove. The seal member includes a locking projection that protrudes toward the side wall. The side wall includes a locking recess to which the locking projection is locked.

### CROSS-REFERENCE TO RELATED APPLICATIONS

The present application claims priority to and incorporates by reference the entire contents of Japanese Patent Application No. 2025-043716 filed in Japan on Mar. 18, 2025.

### BACKGROUND OF THE INVENTION

### 1. Field of the Invention

The present invention relates to a terminal block.

### 2. Description of the Related Art

As a technique related to a conventional terminal block, for example, Japanese Patent Application Laid-open No. JP 2004-327169 A discloses a connector including a connector housing, a terminal fitting, and a seal gasket provided in an annular recessed groove so as to maintain watertightness between the connector housing and a mating connector housing. The seal gasket is provided with an outside-inside protruding piece from an annular outer-inner edge. The outside-inside protruding piece at the outer edge of the seal gasket includes a locking claw and is locked to a locking reception hole of the connector housing.

In such a terminal block, for example, when a connector housing and a mating connector housing as an attachment target are combined, the seal gasket is elastically deformed in the recessed groove. The inside and outside of the seal gasket are sealed by the elastic force of the elastically deformed seal gasket, but there is room for further improvement regarding the configuration of the terminal block that achieves appropriate sealing performance by the seal gasket in this state.

### SUMMARY OF THE INVENTION

The present invention has been made in view of the above circumstances, and an object of the present invention is to provide a terminal block capable of achieving appropriate sealing performance by a seal gasket.

In order to achieve the above mentioned object, a terminal block according to one aspect of the present invention includes a housing including an attachment surface that abuts on an attachment target, a busbar holding portion that holds a busbar extending in an axial direction, and an annular recessed groove that is provided, in an annular shape, on the attachment surface outside the busbar holding portion around the axial direction and having a bottom surface and a side wall rising from the bottom surface; and a seal member having an annular shape and being provided in the annular recessed groove, wherein the seal member includes a locking projection that protrudes toward the side wall, and the side wall includes a locking recess to which the locking projection is locked.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a perspective view illustrating a state where a terminal block according to a first embodiment is attached to an attachment target schematically illustrated;

FIG. 2 is an exploded perspective view illustrating the terminal block and the attachment target according to the first embodiment;

FIG. 3 is a front view illustrating a seal member according to the first embodiment;

FIG. 4 is a cross-sectional view corresponding to IV-IV cross section of FIG. 1, and is a cross-sectional view illustrating a state immediately before insertion of the seal member according to the first embodiment into an annular recessed groove;

FIG. 5 is a cross-sectional view corresponding to IV- IV cross section of FIG. 1, and is a cross-sectional view illustrating a state where the seal member according to the first embodiment has been inserted into the annular recessed groove;

FIG. 6 is a cross-sectional view of the terminal block according to the first embodiment taken along line IV-IV in FIG. 1;

FIG. 7 is a front view illustrating a seal member according to a second embodiment;

FIG. 8 is a cross-sectional view corresponding to IV-IV cross section of FIG. 1, and is a cross-sectional view illustrating a state immediately before insertion of the seal member according to the second embodiment into an annular recessed groove;

FIG. 9 is a cross-sectional view corresponding to IV-IV cross section of FIG. 1, and is a cross-sectional view illustrating a state where the seal member according to the second embodiment has been inserted into the annular recessed groove; and

FIG. 10 is a cross-sectional view corresponding to the IV-IV cross section of FIG. 1 according to a terminal block of the second embodiment.

### DETAILED DESCRIPTION OF THE PREFERRED EMBODIMENTS

Embodiments according to the present invention will be described below in detail with reference to the drawings. Note that the present invention is not limited by the present embodiment. Moreover, components in the following embodiment include those easily interchangeable by those skilled in the art or substantially identical.

### First embodiment

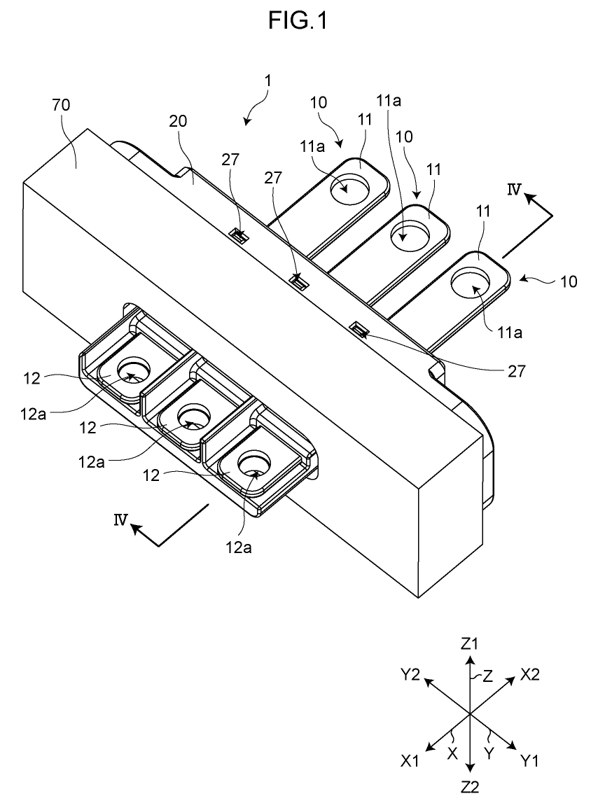

A terminal block 1 of the present embodiment illustrated in FIG. 1 is mounted on a vehicle such as an electric vehicle or a hybrid vehicle, for example, so as to be attached to an attachment target 70 and relay electrical connection between a first device and a second device (not illustrated). The terminal block 1 of the present embodiment includes a plurality of busbars 10. The plurality of busbars 10 each includes, on its one end, a first connection portion 11, to which an external terminal of a first device is electrically connected. In the terminal block 1 of the present embodiment, the plurality of busbars 10 each includes, on its other end, a second connection portion 12, to which an external terminal of a second device is electrically connected. The first device is one of a motor and an inverter, for example, and the second device is the other of the motor and the inverter, for example. The terminal block 1 is not limited to this example, and may be used for, for example, relaying between the first device or the second device and a wiring member, relaying between a wiring member and another wiring member, etc.

In the following description, a direction in which the busbars 10 extend is defined as an axial direction X, a direction orthogonal to the axial direction X and in which the plurality of busbars 10 are arrayed is defined as a width direction Y, and a direction orthogonal to the axial direction X and the width direction Y is defined as a height direction Z. In addition, one side in the axial direction X is defined as one side X1, and the other side is defined as the other side X2. Similarly, one side and the other side are defined as one side Y1 and the other side Y2 in the width direction Y, and one side and the other side are defined as one side Z1 and the other side Z2 in the height direction Z.

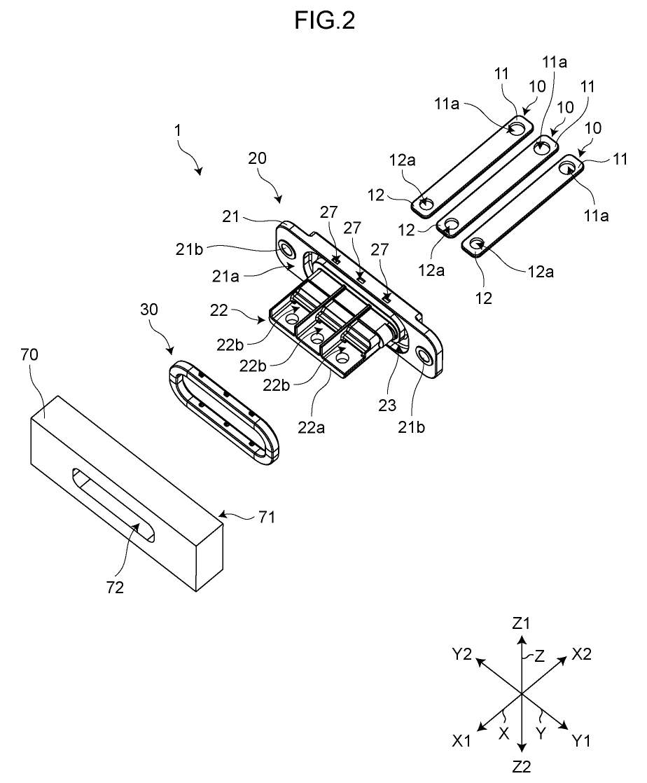

As illustrated in FIGS. 1 and 2, the terminal block 1 includes a housing 20 provided with the plurality of busbars 10. The housing 20 is provided with a seal member 30. The seal member 30 is also referred to as a seal gasket, and is formed of an elastically deformable material such as rubber or resin. The busbar 10 is a terminal fitting formed of a conductive metal material, and is electrically and mechanically connected to the external terminal described above. In the terminal block 1, three busbars 10 are arrayed side by side in the width direction Y.

The busbar 10 includes a first connection portion 11 and a second connection portion 12, and is formed in a long rectangular plate shape elongated in the axial direction X. The first connection portion 11 is formed on the other side X2 of the busbar 10 in the axial direction X, while the second connection portion 12 is formed on the one side X1. In the neighborhood of the end on the other side X2 in the axial direction X of the first connection portion 11, a connection hole 11a penetrating in the height direction Z is provided. Similarly, in the neighborhood of the end on the one side X1 in the axial direction X of the second connection portion 12, a connection hole 12a penetrating in the height direction Z is provided. The first device described above is connected to the connection hole 11a of the first connection portion 11, while the second device described above is connected to the connection hole 12a of the second connection portion 12.

The housing 20 is formed of a material such as an insulating synthetic resin material, and includes a housing body 21, which is a body having a substantially long rectangular plate shape with its longitudinal direction aligned with the width direction Y. A surface on one side X1 in the axial direction X of the housing body 21 is a surface directed in the axial direction X, and is an attachment surface 21a, being a substantially flat surface that abuts on or in the close vicinity of an attachment target surface 71 of the attachment target 70. In the neighborhood of each end on one side Y1 and the other side Y2 in the width direction Y of the housing body 21, an attachment hole 21b is provided individually. The attachment hole 21b is a hole penetrating in the axial direction X, and a bolt (not illustrated) is inserted into the attachment hole 21b to fix the terminal block 1 to the attachment target 70 via the attachment hole 21b.

In a substantially central portion of the housing body 21 of the housing 20 in the width direction Y, a busbar holding portion 22 is provided. The busbar holding portion 22 holds the plurality of busbars 10 extending in the axial direction X so as to orthogonally intersect the attachment surface 21a. When the terminal block 1 is attached to the attachment target 70, the busbar holding portion 22 is inserted into an insertion hole 72 formed in a substantially rounded long rectangular shape elongated in the width direction Y in the attachment target 70. The busbar holding portion 22 is provided with a busbar holding protrusion 22a protruding toward one side X1 in the axial direction X. The busbar holding protrusion 22a is formed in a substantially flat plate shape with the plate surface facing the height direction Z. The busbar holding portion 22 is provided with three busbar attachment portions 22b to which the individual busbars 10 are attached. In FIG. 2, the busbar attachment portion 22b is illustrated in a flat hole shape penetrating in the axial direction X. In the present embodiment, the busbar 10 is attached to the busbar attachment portion 22b by insert molding. The busbar holding protrusion 22a is provided with partition plates corresponding to the three busbars 10. In this manner, the busbar holding portion 22 holds the plurality of busbars 10 arrayed in the width direction Y.

On the attachment surface 21a on the outer side of the busbar holding portion 22 around the axial direction X, there is provided an annular recessed groove 23 in which a recessed groove is formed in an annular shape so as to surround the busbar holding portion 22. The annular recessed groove 23 is formed in a long annular shape elongated in the width direction Y, that is, the direction in which the plurality of busbars 10 are arrayed. The seal member 30 is fitted into the annular recessed groove 23. The seal member 30 is formed in a long annular shape elongated in the direction in which the busbars 10 are arrayed.

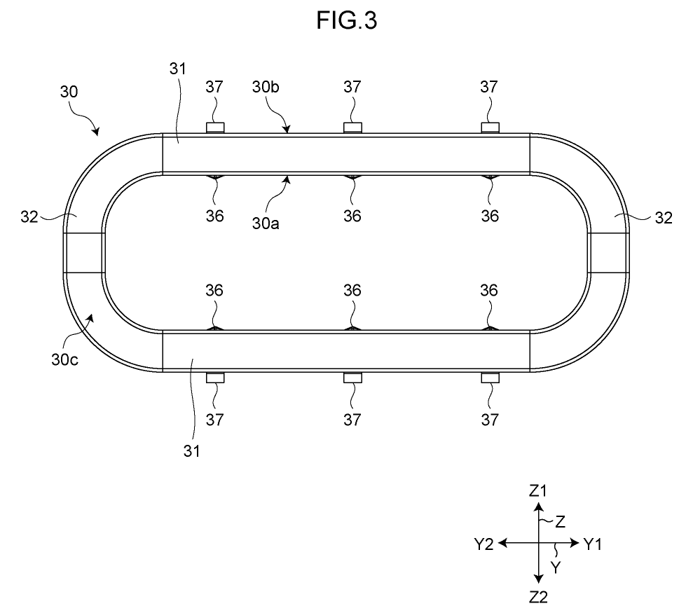

As illustrated in FIG. 3, the seal member 30 includes: an inner side surface 30a having an annular shape; and an outer side surface 30b having an annular shape. In the seal member 30, a long portion 31 which is a portion elongated substantially in a straight line shape in the width direction Y is provided on each of one side Z1 and the other side Z2 in the height direction Z. In addition, the seal member 30 is provided with two connection portions 32 which are formed to be curved so as to connect the end on one side Y1 and the end on the other side Y2 in the width direction Y of the two long portions 31. The annular recessed groove 23 of the housing 20 is formed in substantially the same outer shape as the seal member 30 (long annular shape elongated in the direction in which the busbars 10 are arrayed).

The inner side surface 30a in each long portion 31 of the seal member 30 is provided with three pressure contact projections 36. The three pressure contact projections 36 are arranged at substantially equal intervals in the width direction Y. The outer side surface 30b of each long portion 31 of the seal member 30 is provided with three locking projections 37. The three locking projections 37 are arranged at substantially equal intervals in the width direction Y. In addition, each pressure contact projection 36 in each long portion 31 is provided to face each locking projection 37 in the height direction Z.

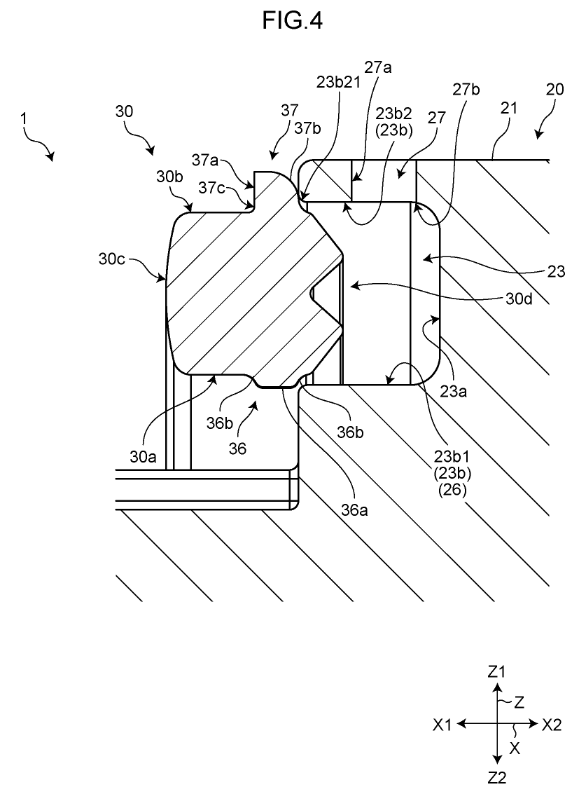

More specifically, the pressure contact projection 36 is formed in a substantially bump-shaped projection when viewed in the axial direction X. As illustrated in FIG. 4, in the pressure contact projection 36, a ridge portion 36a having a substantially bump shape is formed in parallel with the axial direction X. The protruding portion including the ridge portion 36a of the pressure contact projection 36 is connected to the inner side surface 30a by a connection portion 36b, being a recessed curved portion, at the ends on one side X1 and the other side X2 in the axial direction X.

In addition, on one side X1 of the locking projection 37 in the axial direction X, an abutment surface 37a having a flat surface shape is formed as illustrated in FIG. 4. On the other side X2 of the locking projection 37 in the axial direction X, a protruding curved portion 37b is formed in a protruding curved shape.

In this manner, in the seal member 30, the plurality of locking projections 37 is provided on the outer side surface 30b which is one of the inner side surface 30a and the outer side surface 30b in the annular shape, while the plurality of pressure contact projections 36 is provided on the inner side surface 30a which is the other of the inner side surface 30a and the outer side surface 30b in the annular shape.

The cross sections of the long portion 31 and the connection portion 32 of the seal member 30 are each formed in a substantially rectangular shape. A surface of the seal member 30 on one side X1 in the axial direction X is a close contact surface 30c that comes into close contact with the attachment target surface 71 of the attachment target 70. The close contact surface 30c is formed in an annular shape around the axial direction X. A cross section of the close contact surface 30c has a gentle bump shape. On the other side X2 in the axial direction X of the seal member 30, a lip 30d having two bump-shaped cross sections is provided in a continuous annular shape.

As illustrated in FIG. 4, the annular recessed groove 23 has a bottom surface 23a and a side wall 23b rising from the bottom surface 23a. The side wall 23b includes: a side wall 23b1 on an inner side in the annular shape; and a side wall 23b2 on an outer side in the annular shape. The side wall 23b2 on the outer side, which is one of the side wall 23b1 on the inner side and the side wall 23b2 on the outer side in the annular shape of the annular recessed groove 23, is provided with a locking recess 27 to which the locking projection 37 is locked. In addition, an abutment surface 26 with which the pressure contact projection 36 comes into pressure contact for abutment is provided on the side wall 23b1 on the inner side, which is the other side wall 23b out of the side wall 23b1 on the inner side and the side wall 23b2 on the outer side in the annular shape of the annular recessed groove 23. In other words, the abutment surface 26 is a part of the wall surface of the side wall 23b1 on the inner side.

In the present embodiment, the locking recess 27 is provided as three holes penetrating each of the side walls 23b2 on the outer side formed long in a substantially straight line shape in the width direction Y on one side Z1 and the other side Z2 in the height direction Z of the annular recessed groove 23 corresponding to the three locking projections 37 in each long portion 31 of the seal member 30. FIGS. 1 and 2 illustrate three locking recesses 27 on one side Z1 in the height direction Z. Each of the locking recesses 27 is formed in a substantially long rectangular shape slightly longer in the width direction Y. As illustrated in FIG. 4, one side X1 of the locking recess 27 in the axial direction X is a locking surface 27a having a substantially flat surface shape.

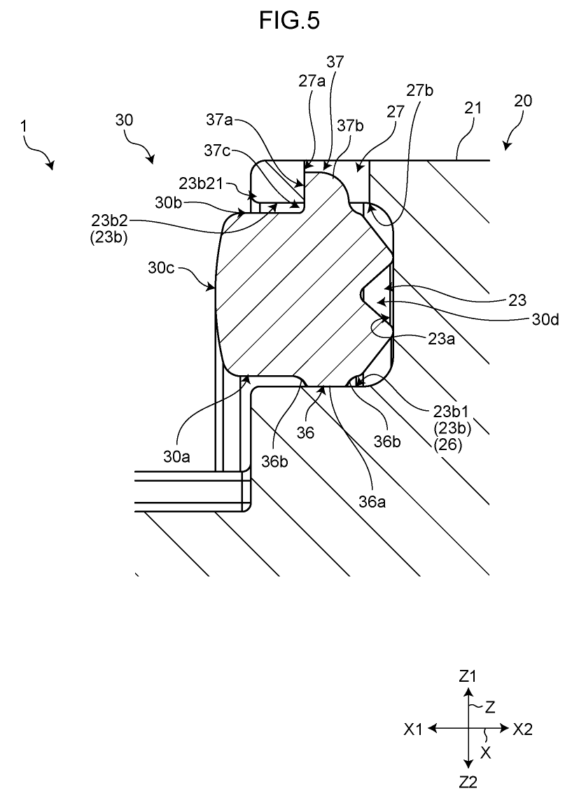

A first step of assembly of the terminal block 1, is, as illustrated in FIG. 4, directing the lip 30d of the seal member 30 toward the annular recessed groove 23 side of the housing 20 (housing body 21), and bringing the seal member 30 close to the annular recessed groove 23 from one side X1 in the axial direction X. When the seal member 30 is inserted into the annular recessed groove 23, as illustrated in FIG. 5, the pressure contact projection 36 abuts on the abutment surface 26 of the annular recessed groove 23, and the locking projection 37 is inserted into and locked to the locking recess 27. When the seal member 30 is inserted into the annular recessed groove 23, the protruding curved portion 37b of the locking projection 37 comes into sliding contact with an inner edge 23b21 of the side wall 23b2 on the outer side so that the seal member 30 is gradually deformed. This reduces the assembling resistance of the seal member 30 to the annular recessed groove 23, facilitating assembly of the seal member 30 to the annular recessed groove 23. When the locking projection 37 is positioned in the locking recess 27, the abutment surface 37a of the locking projection 37 abuts on or becomes abuttable on the locking surface 27a of the locking recess 27. This prevents the locking projection 37 from easily escaping to the one side X1 in the axial direction X. In this manner, the seal member 30 is locked and temporarily held in the annular recessed groove 23. Therefore, even if the terminal block 1 is transported in a state where the seal member 30 is temporarily held in the annular recessed groove 23, the seal member 30 would not easily fall off from the annular recessed groove 23 due to vibration or the like, making it possible to smoothly perform the assembling operation of the terminal block 1.

The pressure contact projection 36 is provided to face the locking projection 37 in the height direction Z. Therefore, the abutment of the pressure contact projection 36 on the abutment surface 26 causes the locking projection 37 to be satisfactorily biased outward so as to be reliably inserted into and locked to the locking recess 27. The pressure contact projection 36 need not bias the locking projection 37 outward after the locking projection 37 is completely locked to the locking recess 27. Therefore, after completion of the locking of the locking projection 37 with the locking recess 27, the pressure contact projection 36 can have a projection height (a height from the inner side surface 30a of the pressure contact projection 36) that is not in pressure contact with the abutment surface 26. In other words, the pressure contact projection 36 can have a projection height sufficiently smaller than the projection height of the locking projection 37 (the height of the locking projection 37 from the outer side surface 30b).

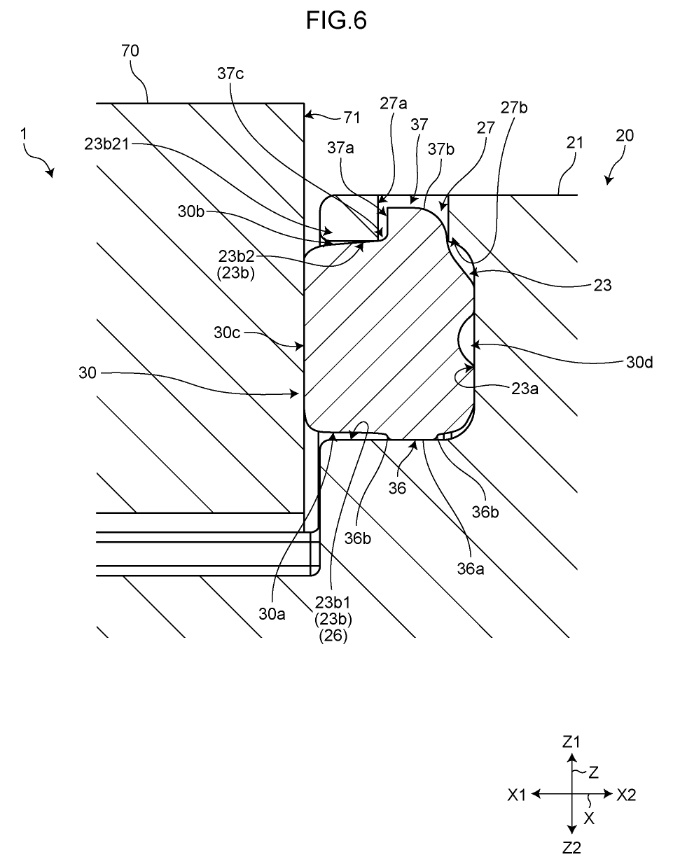

Subsequently, the busbar holding portion 22 of the terminal block 1 is inserted into the insertion hole 72 of the attachment target 70, the attachment target surface 71 of the attachment target 70 is brought close to the attachment surface 21a of the housing body 21 to achieve abutment, and the terminal block 1 is attached to the attachment target 70. At this time, as illustrated in FIG. 6, the close contact surface 30c of the seal member 30 is pressed by the attachment target surface 71 of the attachment target 70, causing the seal member 30 to deform inside the annular recessed groove 23. The seal member 30 receives a compressive force in the axial direction X by the attachment target surface 71 and the bottom surface 23a of the annular recessed groove 23, causing the lip 30d to come into close contact with the bottom surface 23a of the annular recessed groove 23, and the close contact surface 30c comes into close contact with the attachment target surface 71. Subsequently, the seal member 30 crushed in the axial direction X is deformed so as to spread in the height direction Z in the long portion 31. This causes the surroundings of a base portion 37c of the locking projection 37 to come into close contact with the surroundings of an edge portion 27b on the side of the side wall 23b2 on the outer side of the locking recess 27, so as to seal the locking recess 27. In this manner, the inside and the outside of the seal member 30 are sealed.

### Second embodiment

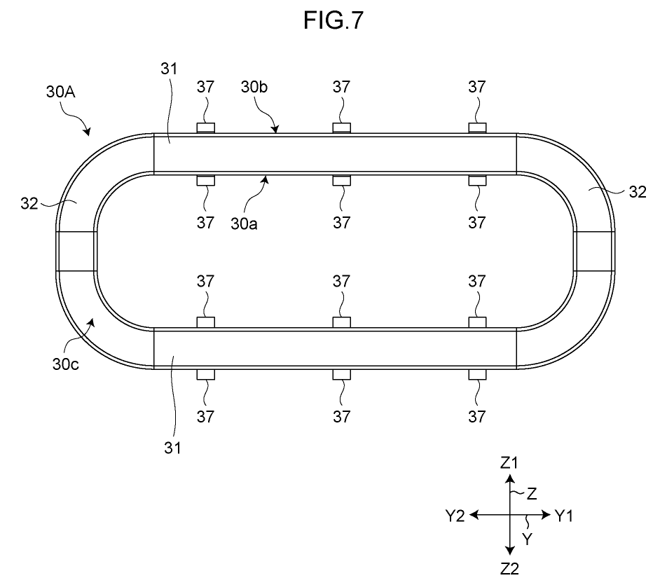

Next, a second embodiment will be described with reference to FIGS. 7-10. In a terminal block 1A of the present embodiment, as illustrated in FIG. 7, instead of the seal member 30 including the plurality of pressure contact projections 36 provided on the inner side surface 30a in the annular shape and the plurality of locking projections 37 provided on the outer side surface 30b in the annular shape, there is provided a seal member 30A including a plurality of locking projections 37 provided on both the inner side surface 30a and the annular outer side surface 30b in the annular shape, in place of the plurality of pressure contact projections 36 provided on the inner side surface 30a. Accordingly, in the following description, the same members or the same portions as those of the first embodiment are denoted by the same reference numerals, and the description thereof will be omitted or simplified.

In the seal member 30A, three locking projections 37 are provided on each inner side surface 30a and each outer side surface 30b of the annular shape in the two long portions 31. The locking projections 37 on the inner side surface 30a and the outer side surface 30b of each of the long portions 31 are provided to face each other in the height direction Z. The three locking projections 37 on each of the inner side surfaces 30a and each of the outer side surfaces 30b are provided at substantially equal intervals in the width direction Y.

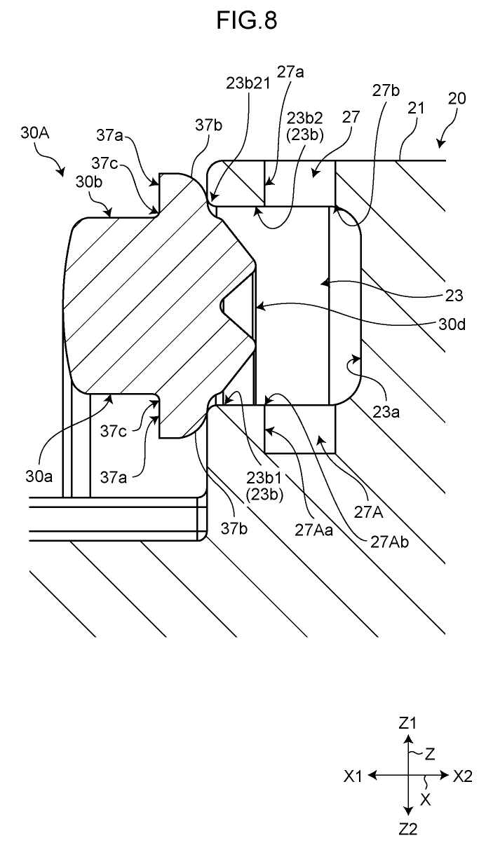

As illustrated in FIG. 8, the annular recessed groove 23 includes a locking recess 27A provided in the side wall 23b1 on the inner side, corresponding to the locking projection 37 provided on the inner side surface 30a of the seal member 30A. Although not illustrated, the locking recess 27A is formed in a substantially long rectangular shape similarly to the locking recess 27 provided on the side wall 23b2 on the outer side. A surface on one side X1 in the axial direction X of the locking recess 27A is a locking surface 27Aa having a flat surface shape. The locking recess 27A is formed in a recessed shape.

In the side wall 23b2 on the outer side of the annular recessed groove 23, similarly to the first embodiment, a locking recess 27 serving as a through hole is provided corresponding to the locking projection 37 on the outer side surface 30b of the seal member 30A.

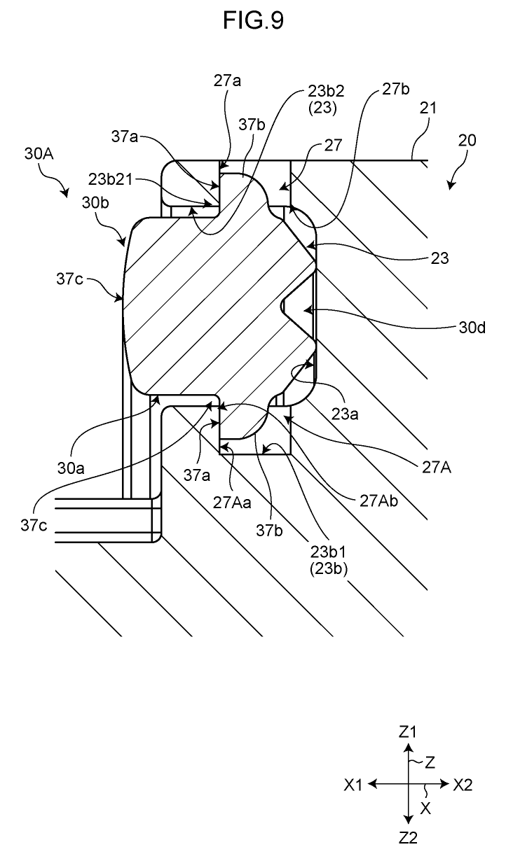

A first step of assembling the terminal block 1 is, as illustrated in FIG. 8, directing the lip 30d of the seal member 30A toward the annular recessed groove 23 side of the housing 20 (housing body 21), and bringing the seal member 30A close to the annular recessed groove 23 from one side X1 in the axial direction X. When the seal member 30A is inserted into the annular recessed groove 23, as illustrated in FIG. 9, the locking projection 37 on the inner side surface 30a and the locking projection 37 on the outer side surface 30b of the seal member 30A are inserted into and locked to the locking recesses 27A and 27, respectively. At this time, the abutment surface 37a of the locking projection 37 abuts on or becomes abuttable on the locking surfaces 27Aa and 27a of the locking recesses 27A and 27. In this manner, the seal member 30A is locked to the annular recessed groove 23 and temporarily held.

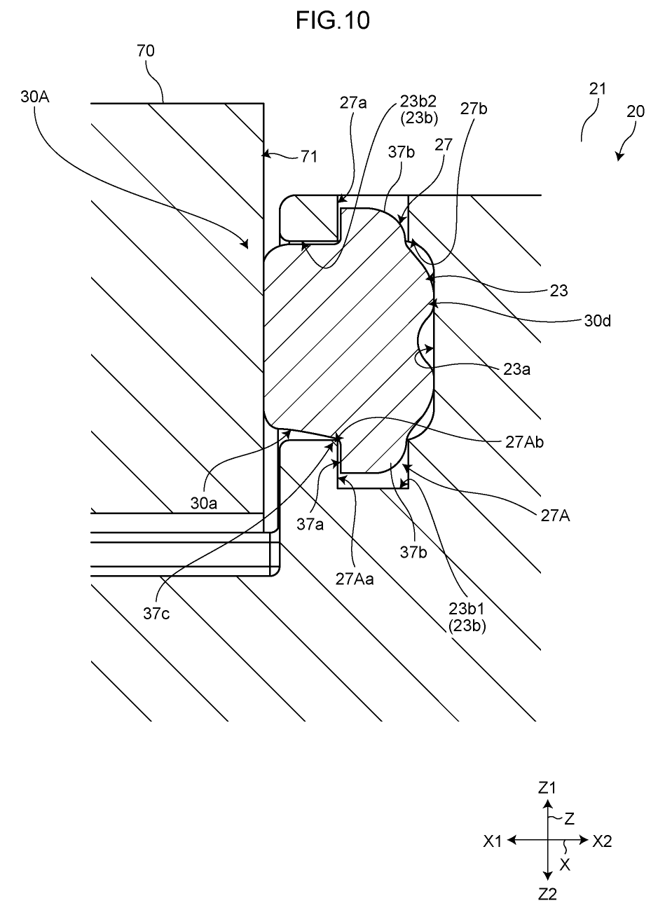

Subsequently, the busbar holding portion 22 of the terminal block 1A is inserted into the insertion hole 72 of the attachment target 70, the attachment target surface 71 of the attachment target 70 is brought close to abut on the attachment surface 21a of the housing body 21, and the terminal block 1 is attached to the attachment target 70. At this time, as illustrated in FIG. 10, the close contact surface 30c of the seal member 30A is pressed by the attachment target surface 71 of the attachment target 70, causing the seal member 30A to deform inside the annular recessed groove 23. The lip 30d of the seal member 30A comes into close contact with the bottom surface 23a of the annular recessed groove 23, and the close contact surface 30c comes into close contact with the attachment target surface 71. Subsequently, the seal member 30A crushed in the axial direction X in the long portion 31 is deformed so as to spread in the height direction Z. This causes the surroundings of the base portion 37c of the locking projection 37 of each of the inner side surface 30a and the outer side surface 30b to come into close contact with the surroundings of the edge portions 27Ab and 27b on the side wall 23b side of the locking recesses 27A and 27, so as to seal the locking recesses 27A and 27.

The terminal blocks 1 and 1A described above include the housing 20 and the seal member 30. The housing 20 includes: the attachment surface 21a that abuts on the attachment target 70; the busbar holding portion 22 that holds the busbar 10 extending in the axial direction X; and the annular recessed groove 23 provided, in an annular shape, on the attachment surface 21a outside the busbar holding portion 22 around the axial direction X and having the bottom surface 23a and the side wall 23b rising from the bottom surface 23a. The seal member 30 has an annular shape and is provided in the annular recessed groove 23. The seal member 30 includes the locking projection 37 that protrudes toward the side wall 23b. The side wall 23b includes the locking recesses 27 and 27A to which the locking projection 37 is locked.

This makes it possible to reduce the force applied to the annular recessed groove 23 when the seal members 30 and 30A are elastically deformed. For example, a certain seal members is formed to include a projection that comes into pressure contact with the side wall of the annular recessed groove on each of the inner side surface and the outer side surface, and the projection comes into pressure contact with the side wall 23b of the annular recessed groove 23 when the seal member is temporarily held. In the case of such a seal member, when the seal member is deformed so as to be crushed in the axial direction X by the attachment target surface 71 of the attachment target 70, the seal member expands in the height direction Z to cause the projection for temporary holding to strongly press the side wall of the annular recessed groove 23. Therefore, in order to cope with this pressing force, it has been sometimes necessary to take measures such as enlargement of the housing.

However, according to the seal members 30 and 30A of the present embodiment, the temporary holding of the seal members 30 and 30A in the annular recessed groove 23 can be performed by the locking projections 37 and the locking recesses 27 and 27A that are locked in the axial direction X and loosely fitted in the height direction Z. Therefore, even if the terminal block 1 is attached to the attachment target 70 and the seal members 30 and 30A are elastically deformed in the height direction Z, it is possible to suppress application of an excessively strong force to the side wall 23b by the locking projections 37 and 37A. In addition, the locking recesses 27 and 27A are sealed by the base portion 37c of the locking projection 37. In this manner, it is possible to achieve appropriate sealing performance by the seal members 30 and 30A as seal gaskets.

In the seal member 30, the locking projection 37 is provided on the outer side surface 30b which is one of the inner side surface 30a and the outer side surface 30b in an annular shape, the pressure contact projection 36 is provided on the inner side surface 30a which is the other of the inner side surface 30a and the outer side surface 30b in the annular shape, the locking recess 27 on which the locking projection 37 is locked is provided on the side wall 23b2 on the outer side which is one of the side wall 23b1 on the inner side and the side wall 23b2 on the outer side in the annular shape of the annular recessed groove 23, and the abutment surface 26 on which the pressure contact projection 36 abuts is provided on the side wall 23b1 on the inner side which is the other of the side wall 23b1 on the inner side and the side wall 23b2 on the outer side in the annular shape of the annular recessed groove 23.

With this configuration, since the locking projection 37 is provided on the outer side surface 30b of the seal member 30 corresponding to the side wall 23b2 on the outer side formed thinner than the inner side of the annular recessed groove 23, it is possible to suppress reception of a strong force by the side wall 23b2 on the outer side when the seal member 30 is deformed.

In the seal member 30A, the locking projection 37 is provided on both the inner side surface 30a and the outer side surface 30b in the annular shape, and the locking recess 27 to which the locking projection 37 is locked is provided on both the side walls 23b, namely, the side wall 23b1 on the inner side and the side wall 23b2 on the outer side, in the annular shape of the annular recessed groove 23. With this configuration, the locking projection 37 is provided on both the inner side surface 30a and the outer side surface 30b on the annular shape of the seal member 30A, making it possible to temporarily hold the seal member 30A in the annular recessed groove 23 further reliably.

Note that the terminal block according to the above-described embodiment of the present invention is not limited to the above-described embodiment, and various modifications can be made within the scope described in the claims.

In the seal member 30, according to the above description, the pressure contact projection 36 is provided on the inner side surface 30a, and the locking projection 37 is provided on the outer side surface 30b. Alternatively, the pressure contact projection 36 may be provided on the outer side surface 30b, and the locking projection 37 may be provided on the inner side surface 30a. In the seal member 30, the pressure contact projection 36 and the locking projection 37 are provided at positions facing each other, but the pressure contact projection 36 and the locking projection 37 may be provided at positions shifted in the width direction Y. Similarly, in the seal member 30A, the locking projections 37 on the inner side surface 30a and the outer side surface 30b may be provided at positions shifted in the width direction Y. In the seal member 30A, the locking projection 37 is provided on both the inner side surface 30a and the outer side surface 30b, but the locking projection 37 may be provided only on one of the inner side surface 30a and the outer side surface 30b.

The terminal block according to the present embodiment may be configured by appropriately combining the components of the above-described embodiment and modifications.

The terminal block according to the present embodiments has an effect of achieving appropriate sealing performance by the seal gasket.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A terminal block comprising:
a housing including an attachment surface that abuts on an attachment target, a busbar holding portion that holds a busbar extending in an axial direction, and an annular recessed groove that is provided, in an annular shape, on the attachment surface outside the busbar holding portion around the axial direction and having a bottom surface and a side wall rising from the bottom surface; and
a seal member having an annular shape and being provided in the annular recessed groove, wherein
the seal member includes a locking projection that protrudes toward the side wall, and
the side wall includes a locking recess to which the locking projection is locked.

2. The terminal block according to claim 1, wherein
the seal member has a configuration in which the locking projection is provided on one of an inner side surface and an outer side surface in the annular shape, and a pressure contact projection is provided on the other of the inner side surface and the outer side surface in the annular shape,
the locking recess to which the locking projection is locked is provided on the one of the side wall on an inner side and the side wall on an outer side in the annular shape of the annular recessed groove, and
the other side wall of the side wall on the inner side and the side wall on the outer side in the annular shape of the annular recessed groove is provided with an abutment surface on which the pressure contact projection abuts.

3. The terminal block according to claim 1, wherein
the seal member is provided with the locking projection on both an inner side surface and an outer side surface in the annular shape, and
both the side wall on an inner side and the side wall on an outer side in the annular shape of the annular recessed groove are provided with the locking recess to which the locking projection is locked.
